(19) United States
(12) Patent Application Publication
(10) Pub. No.: US 2006/0188108 A1
(43) Pub. Date: Aug. 24, 2006

(54) Headset with optimized treble reproduction

(76) Inventor: Florian Meinhard Konig, Germering (DE)

Correspondence Address: QUARLES & BRADY LLP, 411 E. WISCONSIN AVENUE, SUITE 2040, MILWAUKEE, WI, 53202-4497, US

(21) Appl. No.: 11/348,424

(22) Filed: Feb. 6, 2006

(30) Foreign Application Priority Data
Feb. 7, 2005 (DE) 10 2005 005 759.4

(51) Int. Cl. H04R 1/10; H04R 25/00

(52) U.S. Cl. 381/74; 381/384

(57) ABSTRACT

A headset includes at least one wideband acoustic transducer located decentrally in a housing for the reproduction of an audio signal within the range of at least essentially the full audible spectrum. At least one treble acoustic transducer for the reproduction of the treble range of the audible frequency spectrum is located in the vicinity of the edge of the wideband acoustic transducer pointing away from the center of the housing.

### CROSS REFERENCES TO RELATED APPLICATIONS

This application claims the priority benefit of German Patent Application No. 10 2005 005 759.4 filed on Feb. 7, 2005.

### STATEMENT REGARDING FEDERALLY SPONSORED RESEARCH

Not Applicable.

### TECHNICAL FIELD

This invention relates to a headset with at least one wideband acoustic transducer that is located decentrally in a housing for the reproduction of an audio signal within the range of essentially the full spectrum of the audible spectrum.

### DESCRIPTION OF THE BACKGROUND ART

A headset having a decentrally located acoustic transducer is known, for example, from WO 91 01 616 A2. The acoustic transducer of this known headset is designed for the reproduction of an auditory event that is perceived by the headset user in front of the headset user's head, shifted primarily downward and forward in the line of vision. This particular known headset provides in-front-of-head localization stereo headset, which is a subset of known headsets that provide outside-the-head localization of auditory events. This outside-the-head effect can be explained by the directional filtering effect, or comb filtering effect, of the pinna, i.e. the outer ear of a headset user's ear. This outside-the-head perception of the auditory event has the advantage over the in-head localization of conventional headsets that have a centrally located acoustic transducer in each headset housing, in that the user perceives the auditory event in a manner that corresponds to the normal experience of hearing auditory events that take place at some distance from the user's ears.

The prior art also describes a surround-sound headset as a development of this in-front localization stereo headset with at least one additional acoustic transducer which is also located decentrally, namely shifted upward and predominantly toward the rear (DE 42 36 765 A1). With this headset, auditory events outside the head of the headset user can be perceived not only in front of the headset wearer's head, but also behind and to the side of the head. This headset represents the more general case of a headset for outside-the-head localization of the sound.

### SUMMARY OF THE INVENTION

One object of the present invention is to provide a headset having optimized sound reproduction quality for outside-the-head localization of auditory events. The present invention teaches that this object can be accomplished by providing a headset including at least one wideband acoustic transducer and at least one treble acoustic transducer. The at least one wideband acoustic transducer is located decentrally in a housing and reproduces an audio signal within the range of at least essentially the full audible spectrum. The at least one treble acoustic transducer reproduces the treble range of the audible frequency spectrum and is located in the vicinity of the edge of the wideband acoustic transducer pointing away from the center of the housing.

It has been found that, surprisingly, the use of a treble acoustic transducer in a peripheral area of the wideband loudspeaker pointing away from the center of the headset housing optimizes the directional filtering action of the pinna for outside-the-head localization of audible events. This phenomenon can probably be explained by the fact that a small volume loss of the reproduction of sound as a result of the decentral location of the wideband acoustic transducer is compensated by the additional treble acoustic transducer in the special position relative to the wideband acoustic transducer.

The additional treble acoustic transducer preferably transmits the treble frequency spectrum above about 8 kHz. A high-pass filter is also preferably interposed upstream of the treble acoustic transducer. Moreover, the headset can be further optimized for the perception of auditory events primarily in the line of vision in front of the head of the headset wearer by locating the wide band acoustic transducer in the lower half of the housing, primarily shifted forward in the line of vision of a headset user. In addition, to optimize the more general case described in the introduction, for the outside-the-head localization to the benefit of a perception of auditory events around the head of a headset user, an additional wideband acoustic transducer with at least one associated treble acoustic transducer can be located in the upper half of the housing, primarily offset to the rear, i.e. opposite to the line of vision of a headset user.

The foregoing and other objectives and advantages of the invention will appear from the following description. In the description, reference is made to the accompanying drawing which forms a part hereof, and in which there is shown by way of illustration a preferred embodiment of the invention. Such embodiment does not necessarily represent the full scope of the invention, however, and reference is made therefore to the claims herein for interpreting the scope of the invention.

### BRIEF SUMMARY OF THE DRAWINGS

FIG. 1 is a schematic overhead view of an acoustic baffle (buffer board) equipped with two wideband acoustic transducers and additional treble transducers of the housing of one exemplary embodiment of the headset claimed by the invention (surround-sound headset).

### DETAILED DESCRIPTION OF THE PREFERRED EMBODIMENTS

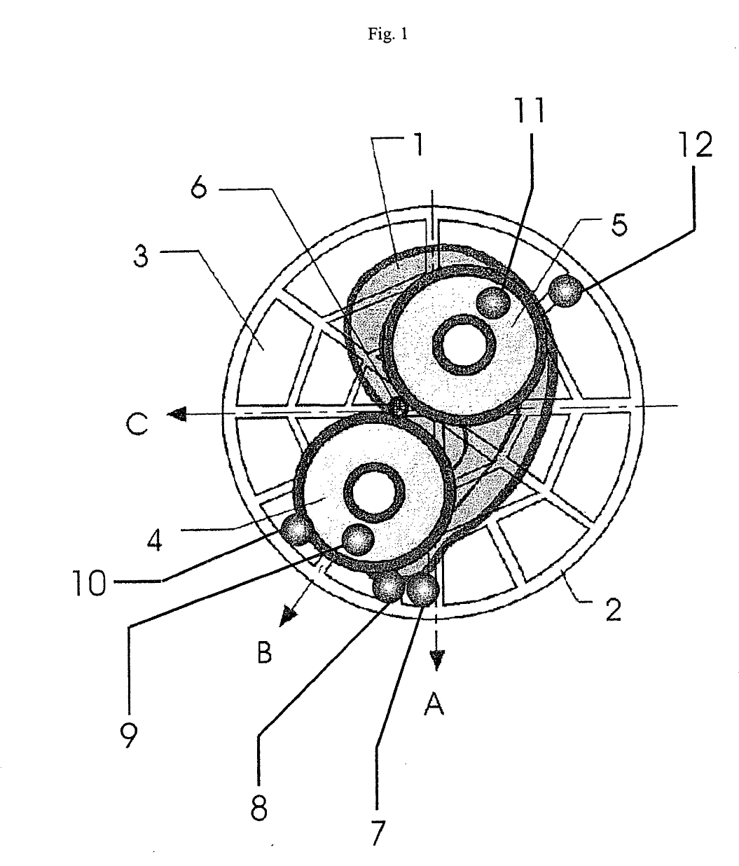

In FIG. 1, the reference number 1 designates a pinna, i.e. an auricle or outer ear of the headset user. Reference number 2 designates a grid-like support structure of an acoustic baffle or buffer board of a headset housing (not shown) positioned over the pinna 1 of the headset user during use. In the embodiment disclosed herein, the center of the support structure 2 of the acoustic baffle corresponds with the center of the headset housing. Reference number 3 designates an acoustic damping cover of this structure, which is realized as a component of the acoustic baffle or of the buffer board, e.g. in the form of a felt insulating material. Reference number 4 is a primary wideband acoustic transducer in a radial position identified by an arrow B, beginning from the center of the acoustic baffle 2 perpendicularly downward (in the direction of the arrow A) and forward in the line of vision (Arrow C) of a headset user. Reference number 5 is a secondary wideband acoustic transducer, which is positioned upward, starting from the center of the acoustic baffle 2 and shifted toward the rear. Reference number 6 indicates the imaginary position of a treble acoustic transducer between the two wideband acoustic baffles 4 and 5, which position does not correspond to a preferred position for additional treble acoustic transducers. Reference numbers 7 to 12 are treble acoustic transducers which correspond to preferred positions for additional treble acoustic transducers of the present invention.

Preferably, the treble acoustic transducers 7 to 12 are located in the vicinity of the edge of the wideband acoustic transducers 4, 5 pointing away from the center of the headset housing or the acoustic baffle 2,3, above or outside said acoustic transducers 4, 5. The treble acoustic transducer 9 comes to lie inside the edge of the primary wideband acoustic transducer 4, positioned above the latter in the plane of the drawing and shifted slightly in the counterclockwise direction relative to the radial Arrow B. The treble acoustic transducer 11 comes to lie in a corresponding position symmetrical to the center of the acoustic baffle 2, 3 relative to the secondary wideband acoustic transducer 5. The treble acoustic transducer 10 comes to lie on the edge of the primary wideband acoustic transducer 4, displaced in the clockwise direction relative to the radial arrow B. The treble acoustic transducer 12 comes to lie in a corresponding symmetrical position with respect to the center of the acoustic baffle 2, 3, but at a slight distance from the edge, relative to the secondary wideband acoustic transducer 5. The treble acoustic transducer 8 comes to lie adjacent to the edge of the primary wideband acoustic transducer 4, outside the latter and displaced in the counterclockwise direction relative to the radial arrow B. The treble acoustic transducer 7 comes to lie displaced even farther in the counterclockwise direction relative to the radial arrow B and at some distance from the edge of the acoustic transducer 4.

The positions of the multiple treble acoustic transducers 7 to 12 are illustrated only by way of example. Instead of the multiple treble acoustic transducers, only one single treble acoustic transducer can be associated with each wideband acoustic transducer 4, 5. Some or all of these treble acoustic transducers, on account of their special positions, are used for the above mentioned optimization of the outside-the-head localization of the auditory events generated by the headset. A treble acoustic transducer located in the imaginary position 6, however, which is relatively close to the center of the acoustic baffle 2, 3, would not contribute significantly to the optimization of the outside-the-head location of the sound, and is thus not preferred.

The contribution of the treble acoustic transducer to the optimization of the outside-the-head localization of auditory events can be enhanced by special, e.g. tube-shaped or horn-shaped acoustic guides that are positioned in front of said acoustic transducers and are oriented toward the central canal of the respective ear of the headset user. These acoustic guides preferably have a diameter that is approximately equal to that of the treble acoustic transducer of approximately 15 mm and a cylinder element length that is less than 15 mm. Preferably, the treble acoustic transducers 9 to 12 are connected to the primary and secondary wideband acoustic transducers 4 in parallel by means of a high-pass filter with a separation frequency of approximately 8 kHz.

While there has been shown and described what is at present considered the preferred embodiment of the invention, it will be obvious to those skilled in the art that various changes and modifications can be made therein without departing from the scope of the invention defined by the appended claims.

I claim:

1. A headset comprising:
at least one wideband acoustic transducer located decentrally in a housing for the reproduction of an audio signal within the range of at least essentially the full audible spectrum; and
at least one treble acoustic transducer for the reproduction of a treble range of the audible frequency spectrum, said at least one treble acoustic transducer being located in the vicinity of an edge of the wideband acoustic transducer and pointing away from the center of the housing.

2. The headset as in claim 1, in which the at least one treble acoustic transducer transmits a treble frequency spectrum above approximately 8 kHz.

3. The headset as in claim 2, in which a high-pass filter is connected upstream of the at least one treble acoustic transducer.

4. The headset as in claim 1, in which the wideband acoustic transducer is located in a lower half of the housing, primarily offset forward in a line of vision of a headset user.

5. The headset as in claim 4, in which an additional wideband acoustic transducer with at least one associated treble acoustic transducer is provided in an upper half of the housing, offset rearwardly opposite the line of vision of the headset user.

6. The headset as in claim 1, in which said at least one treble acoustic transducer is in front of or outside the wideband acoustic transducer.

7. A headset comprising:
at least one wideband acoustic transducer located decentrally in a housing for the reproduction of an audio signal within the range of at least essentially the full audible spectrum; and
at least one treble acoustic transducer for the reproduction of a treble range of the audible frequency spectrum, said at least one treble acoustic transducer being located in the vicinity of an edge of the wideband acoustic transducer and pointing away from the center of the housing in front of or outside the wideband acoustic transducer.

8. The headset as in claim 7, in which the at least one treble acoustic transducer transmits a treble frequency spectrum above approximately 8 kHz.

9. The headset as in claim 8, in which a high-pass filter is connected upstream of the at least one treble acoustic transducer.

10. The headset as in claim 7, in which the wideband acoustic transducer is located in a lower half of the housing, primarily offset forward in a line of vision of a headset user.

11. The headset as in claim 10, in which an additional wideband acoustic transducer with at least one associated treble acoustic transducer is provided in an upper half of the housing, offset rearwardly opposite the line of vision of the headset user.

12. A headset comprising:
at least one wideband acoustic transducer located decentrally in a housing for the reproduction of an audio signal within the range of at least essentially the full audible spectrum, said at least one wideband acoustic transducer being located in a lower half of the housing, primarily offset forward in a line of vision of a headset user; and
at least one treble acoustic transducer for the reproduction of a treble range of the audible frequency spectrum, said at least one treble acoustic transducer being located in the vicinity of an edge of the wideband acoustic transducer and pointing away from the center of the housing.

13. The headset as in claim 12, in which the at least one treble acoustic transducer transmits a treble frequency spectrum above approximately 8 kHz.

14. The headset as in claim 13, in which a high-pass filter is connected upstream of the at least one treble acoustic transducer.

15. The headset as in claim 12, in which an additional wideband acoustic transducer with at least one associated treble acoustic transducer is provided in an upper half of the housing, offset rearwardly opposite the line of vision of the headset user.

16. The headset as in claim 12, in which said at least one treble acoustic transducer is in front of or outside the wideband acoustic transducer.
